(19) United States
(12) Patent Application Publication
(10) Pub. No.: US 2020/0118027 A1
(43) Pub. Date: Apr. 16, 2020

(54) LEARNING METHOD, LEARNING APPARATUS, AND RECORDING MEDIUM HAVING STORED THEREIN LEARNING PROGRAM

(71) Applicant: FUJITSU LIMITED, Kawasaki-shi (JP)

(72) Inventors: Ryota Kikuchi, Kawasaki (JP); Takuya Nishino, Atsugi (JP)

(73) Assignee: FUJITSU LIMITED, Kawasaki-shi (JP)

(21) Appl. No.: 16/580,512

(22) Filed: Sep. 24, 2019

(30) Foreign Application Priority Data
Oct. 11, 2018 (JP) 2018-192557

(51) Int. Cl. G06N 20/00; G06K 9/62

(52) U.S. Cl. CPC G06N 20/00; G06K 9/6256

(57) ABSTRACT

A machine learning model, in which core tensors are generated, is trained by a computer. The computer performs a process including: extracting, from a plurality of items of pseudo training data generated from a plurality of items of training data for the machine learning model, a plurality of items of determined pseudo training data that are determined as pseudo training data that promotes training of the machine learning model; and training the machine learning model by using the plurality of items of determined pseudo training data.

### CROSS-REFERENCE TO RELATED APPLICATION

This application is based upon and claims the benefit of priority of the prior Japanese Patent Application No. 2018-192557, filed on Oct. 11, 2018, the entire contents of which are incorporated herein by reference.

### FIELD

The embodiments discussed herein are related to a learning method, a learning apparatus, and a non-transitory computer-readable recording medium having stored therein a learning program.

### BACKGROUND

In the field of information security, technical experts have conducted analysis of malware attacks by analyzing communication logs in networks. In this respect, conducting analysis of cyberattacks by using a suspicious activity graph, which is a structure representing, for example, details of targeted attacks and malware activities, based on logs in networks has been introduced. Examples of the related art include International Publication Pamphlet No. WO 2016/171243.

Meanwhile, a graph structure learning technology (hereinafter a form of machine for performing the graph structure learning is referred to as “Deep Tensor”) capable of deep-learning graph-structured data is known. Furthermore, as a method for improving identification accuracy in machine learning, there is a known method in which pseudo training data created by modifying training data is also learned for the purpose of increasing the volume of training data. Examples of the related art include Japanese Laid-open Patent Publication No. 2011-154727.

In the case of analyzing logs in a network, it is considered to perform machine learning on graph-structured data in which hardware devices are regarded as nodes and communications among the hardware devices are regarded as edges. In this case, since the amount of data containing information about malware attacks is significantly smaller than the amount of data not containing information about malware attacks, pseudo training data is generated by modifying data containing information about malware attacks that serves as training data. However, in Deep Tensor, because core tensors are extracted from tensors of input data, pseudo training data obtained by modifying training data does not entirely contribute to improve the identification accuracy.

In one aspect, an object is to provide a learning program, a learning method, and a learning apparatus that hinder degradation of identification accuracy of a machine learning model using core tensors caused by learning pseudo training data.

### SUMMARY

According to an aspect of the embodiments, a machine learning model, in which core tensors are generated, is trained by a computer. The computer performs a process including: extracting, from a plurality of items of pseudo training data generated from a plurality of items of training data for the machine learning model, a plurality of items of determined pseudo training data that are determined as pseudo training data that promotes training of the machine learning model; and training the machine learning model by using the plurality of items of determined pseudo training data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a configuration of a learning apparatus according to an embodiment;

FIG. 2 illustrates an example of ratios of malware attacks;

FIG. 3 illustrates an example of levels of progression of malware;

FIG. 4 illustrates an example of pseudo training data that does not contribute to training;

FIG. 5 illustrates another example of pseudo training data that does not contribute to training;

FIG. 6 illustrates an example of a flow of learning process;

FIG. 7 illustrates an example of training data that is incorrectly identified;

FIG. 8 illustrates an example of statistic data that is used for generating pseudo training data;

FIG. 9 illustrates an example of modification of a sub-graph;

FIG. 10 illustrates an example of modification of a sub-graph indicated by using a core tensor;

FIG. 11 illustrates an example of the determiner that determines whether pseudo training data contributes to training;

FIG. 12 illustrates an example of determination obtained by the determiner;

FIG. 13 illustrates an example of accuracy evaluation performed for training data with added candidate data;

FIG. 14 illustrates an example of a flowchart of learning process according to an embodiment; and

FIG. 15 illustrates an example of a computer that runs a learning program.

### DESCRIPTION OF EMBODIMENTS

Hereinafter, embodiments of a learning program, a learning method, and a learning apparatus disclosed by the present application are described in detail with reference to the drawings. It is noted that these embodiments do not limit the disclosed technology. In addition, the embodiments described below may be combined with each other as appropriate when there is no contradiction.

### EMBODIMENTS

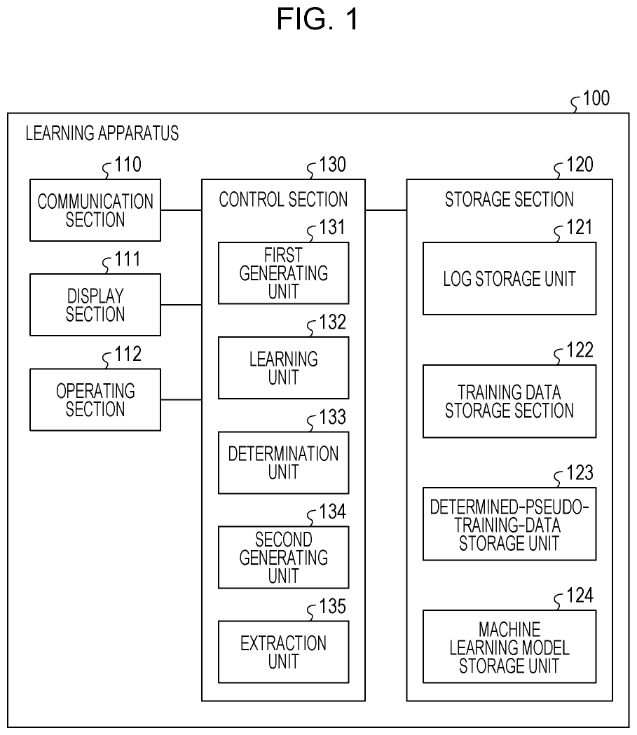

FIG. 1 is a block diagram illustrating an example of a configuration of a learning apparatus according to an embodiment. A learning apparatus 100 illustrated in FIG. 1 is an example of a learning apparatus that trains a machine learning model by extracting particular items of pseudo training data from a set of pseudo training data generated when the volume of training data is insufficient. The particular items of pseudo training data are determined as pseudo training data that promotes training. The learning apparatus 100 trains a machine learning model in which core tensors are generated. The learning apparatus 100 extracts, from a plurality of items of pseudo training data generated from a plurality of items of training data for the machine learning model, a plurality of items of determined pseudo training data that have been determined as pseudo training data that promotes training of the machine learning model. The learning apparatus 100 trains the machine learning model by using the plurality of items of determined pseudo training data. In this manner, the learning apparatus 100 is able to hinder degradation of identification accuracy of a machine learning model using core tensors caused by learning pseudo training data.

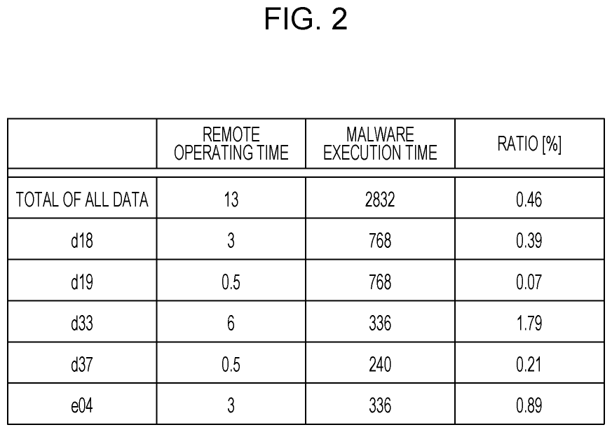

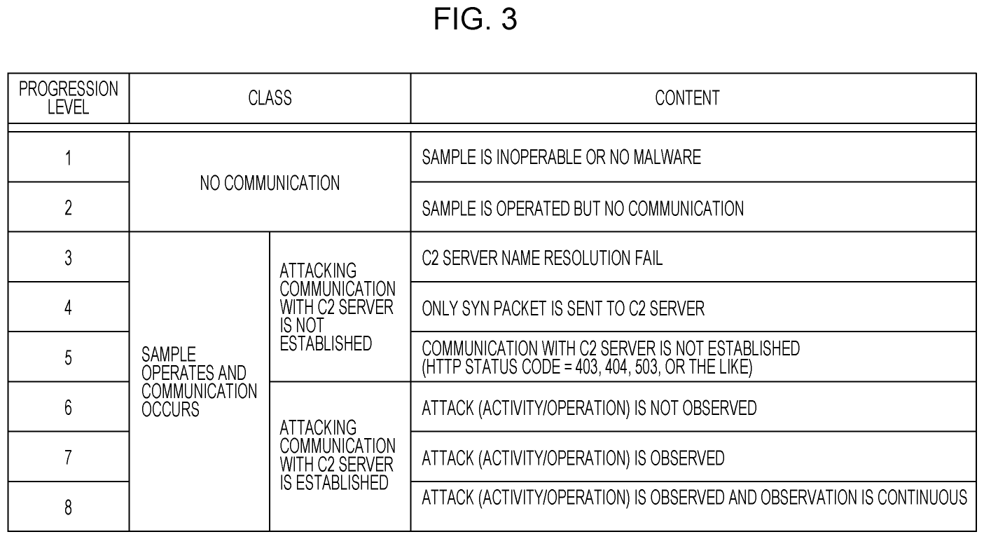

Firstly, malware activities are described with reference to FIGS. 2 and 3. FIG. 2 illustrates an example of ratios of malware attacks. As indicated in FIG. 2, concerning malware, the ratio of an execution time of malware to a remote operating time (an attack), during which the malware communicates with an attacker, is relatively small. Furthermore, the number of data items about which it is determined that malware attacks have been carried out is significantly smaller than the number of data items about which it is determined that malware attacks have not been carried out. Moreover, since a plurality of subspecies exist with respect to individual types of malware, the number of data items relating to a particular subspecies is further lessened. For example, malware d18 and d19 in FIG. 2 are subspecies. In addition, when logs containing information about malware activities are learned, although the number of data items with attacks is small, it is desired to partition the data items with attacks into training data and evaluation data.

FIG. 3 illustrates an example of levels of progression of malware. As illustrated in FIG. 3, malware activities are classified into, for example, eight stages. Regarding malware, actual damages, such as information leakage, are caused by, for example, being operated by an attacker when communication with the attacker is established. Hence, in this embodiment, the conditions of the progression level “6” and the subsequent levels in FIG. 2, in all of which communication with an attacker is established, are assumed to be serious conditions under attacks.

Next, Deep Tensor is described. Deep Tensor is a type of deep learning technology in which tensors (graph information) are used as input. With Deep Tensor, not only learning for a neural network is performed but also sub-graph structures (hereinafter also referred to as sub-graphs or sub-structures) that contribute to identification are automatically extracted. The extraction process is achieved by leaning parameters for tensor decomposition of input tensor data together with performing learning for the neural network.

For example, a graph structure representing an entire item of graph structure data is expressed as a tensor. Further, a tensor is approximated to the product of a core tensor multiplied by matrices by employing structure restricted tensor decomposition. In Deep Tensor, deep learning is performed by inputting the core tensor into a neural network and the core tensor is optimized to be close to a target core tensor by employing an extended backpropagation algorithm. At this time, when the core tensor is expressed as a graph, the graph represents sub-structures in which features are concentrated. In other words, in Deep Tensor it is able to automatically learn important sub-structures from an entire graph by using a core tensor. In the following description, Deep Tensor is expressed as DT in some cases.

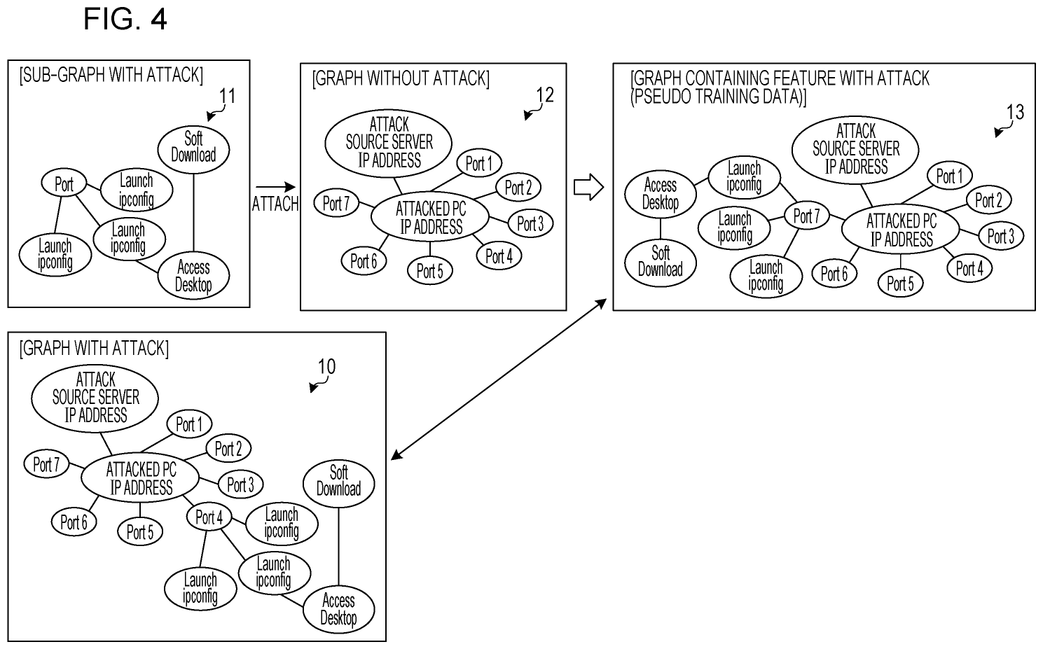

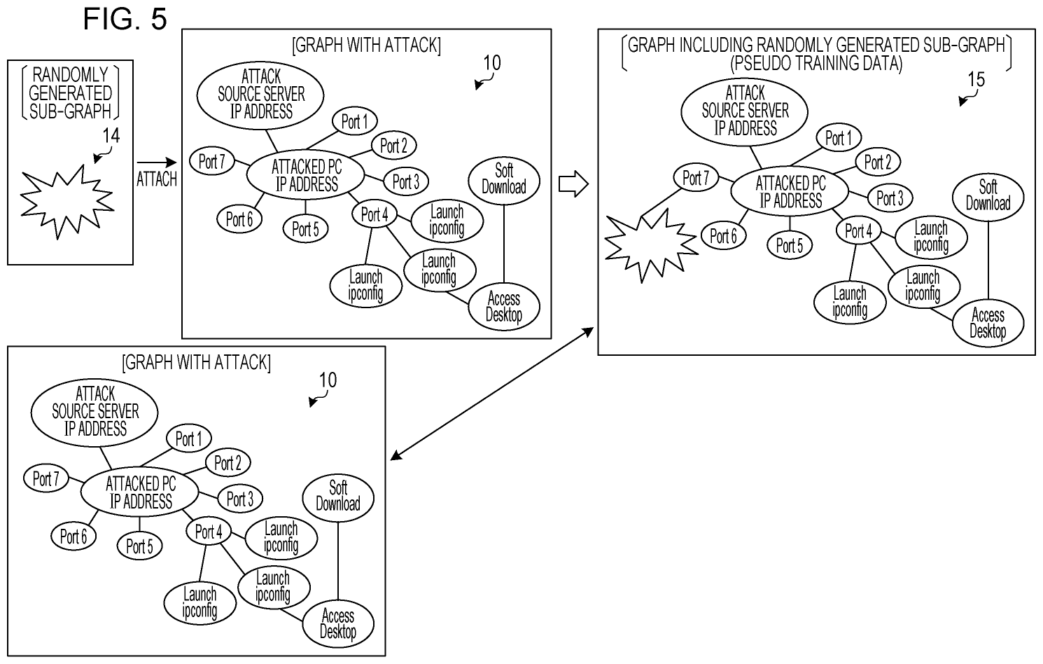

Next, generation of pseudo training data is described with reference to FIGS. 4 and 5. FIG. 4 illustrates an example of pseudo training data that does not contribute to training. The example in FIG. 4 is an example of the case of generating pseudo training data by using as training data a graph with attack 10 that represents data containing information about a malware attack by using a graph-structured data. In the example in FIG. 4, a sub-graph with attack 11 (a portion composed of “Port 4” and nodes coupled to “Port 4” in the graph with attack 10) that is extracted from the graph with attack 10 and contributes to identification is attached to “Port 7” in a graph without attack 12, as a result, a graph involving feature with attack 13 is generated. Thus, the graph involving feature with attack 13 serves as pseudo training data obtained by modifying the graph with attack 10 as training data. At this time, the graph involving feature with attack 13 is similar to the graph with attack 10, and thus, the number of variations of training data is increased. However, when a sub-graph that contributes to identification is extracted from the graph involving feature with attack 13, the sub-graph is similar to the sub-graph 11, and therefore, the degree of contribution of the graph involving feature with attack 13 to training is inferior. As a result, since the graph involving feature with attack 13 does not improve identification accuracy and thus does not contribute to training, the graph involving feature with attack 13 is unsuitable for pseudo training data.

FIG. 5 illustrates another example of pseudo training data that does not contribute to training. The example in FIG. 5 is an example of the case of generating pseudo training data by attaching a randomly generated sub-graph 14 to the graph with attack 10 that serves as training data. This means that, in the example in FIG. 5, the randomly generated sub-graph 14 is attached to the graph with attack 10, so that a graph 15 involving the randomly generated sub-graph 14 is generated. Thus, the graph 15 is pseudo training data obtained by modifying the graph with attack 10 serving as training data. At this time, the graph 15 is similar to the graph with attack 10, and thus, the number of variations of training data is increased. However, when the graph 15 is learned as pseudo training data, the feature of the randomly generated sub-graph 14 may be learned. Hence, the graph 15 does not contribute to training because the graph 15 includes inappropriate data and may degrade identification accuracy, and therefore, the graph 15 is unsuitable for pseudo training data.

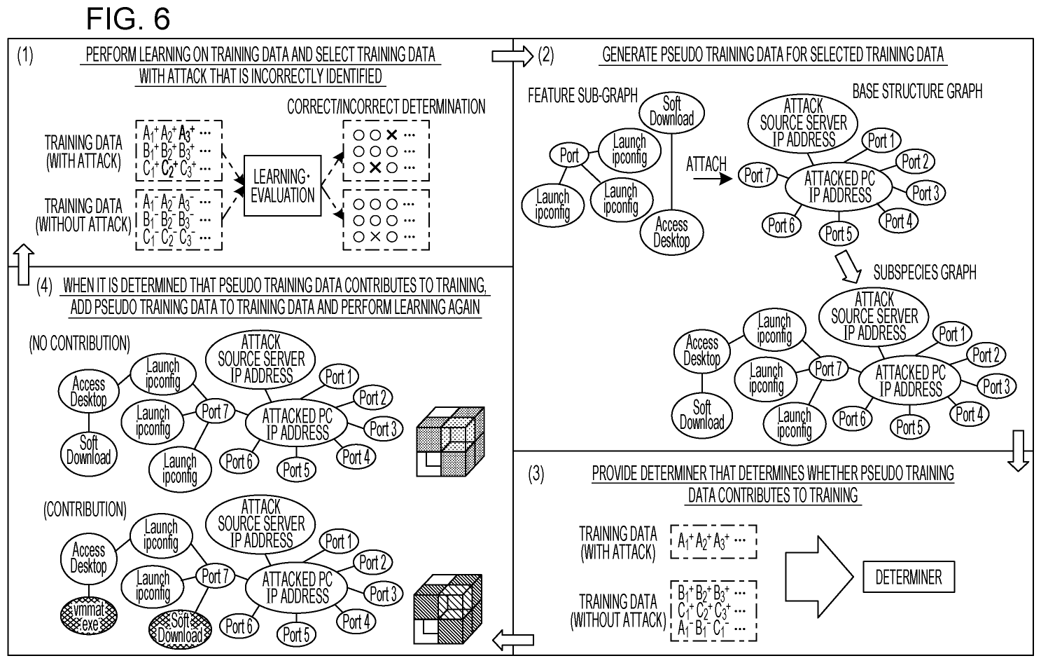

In this regard, this embodiment determines whether generated pseudo training data contributes to training and adds pseudo training data that contributes to training to training data, so that identification accuracy is improved. FIG. 6 illustrates an example of a flow of learning process. As illustrated in FIG. 6, (1) the learning apparatus 100 learns training data and selects an item of training data with attack that is incorrectly identified. (2) The learning apparatus 100 generates an item of pseudo training data (a subspecies graph) based on the selected item of training data. (3) The learning apparatus 100 provides a determiner that determines whether pseudo training data contributes to training. (4) When it is determined by using the determiner of (3) that the item of pseudo training data contributes to training, the learning apparatus 100 adds the item of pseudo training data to training data and performs learning again. The learning apparatus 100 repeats the processes (1) to (4) described above, so that the identification accuracy of machine learning model is improved.

Next, referring back to FIG. 1, a configuration of the learning apparatus 100 is described. The learning apparatus 100 includes a communication section 110, a display section 111, an operating section 112, a storage section 120, and a control section 130. In addition to the functional sections illustrated in FIG. 1, the learning apparatus 100 may include various functional sections that known computers usually include, such as various input devices and various audio output devices.

The communication section 110 is implemented as, for example, a network interface card (NIC). The communication section 110 is a communication interface that is coupled to an information processing device, which is not illustrated in the diagrams, via a network in a wired or wireless manner and performs information communications with the information processing device. The communication section 110 receives from a terminal, for example, training data for learning and new data targeted for identification. The communication section 110 also transmits learning results and identification results to a terminal.

The display section 111 is a display device that displays various kinds of information. The display section 111 is implemented as, for example, a liquid crystal display serving as a display device. The display section 111 displays various screens such as a display screen whose data is input from the control section 130.

The operating section 112 is an input device that receives various operations from a user of the learning apparatus 100. The operating section 112 is implemented as, for example, a keyboard and a mouse serving as input devices. The operating section 112 outputs to the control section 130 operations that is input by the user, as operational information. The operating section 112 may be implemented, to serve as an input device, as a touch panel or the like, and the display device serving as the display section 111 and the input device serving as the operating section 112 may be integrated with each other.

The storage section 120 is implemented as, for example, a semiconductor memory element, such as a random-access memory (RAM) or a flash memory, or a storage device, such as a hard disk or an optical disk. The storage section 120 includes a log storage unit 121, a training data storage unit 122, a determined-pseudo-training-data storage unit 123, and a machine learning model storage unit 124. The storage section 120 stores information that is used for processing in the control section 130.

The log storage unit 121 stores, for example, logs obtained from a terminal or the like. Examples of logs include, for example, command logs in the terminal and communication logs.

The training data storage unit 122 stores first training data that is graph-structured data generated based on logs. The training data storage unit 122 also stores evaluation data that is partitioned from the first training data and used for cross-testing (cross-validation). The training data storage unit 122 also stores second and third training data described later.

The determined-pseudo-training-data storage unit 123 stores, among a set of generated pseudo training data, determined pseudo training data that is determined as pseudo training data that contributes to training.

The machine learning model storage unit 124 stores a first machine learning model that has deep-learned the first to third training data and a second machine learning model (hereinafter also referred to as the determiner) that is used for determining whether generated pseudo training data contributes to training of the first machine learning model. Specifically, the second machine learning model is a determiner that determines the property of subspecies. The second training data is training data obtained by adding an item of determined pseudo training data to the first training data. The second training data may be obtained by successively increasing items of determined pseudo training data added to the first training data. The third training data is training data obtained by adding all items of determined pseudo training data stored in the determined-pseudo-training-data storage unit 123 to the first training data. These machine learning models store, for example, various parameters (weight coefficients) for the neural network and a method of tensor decomposition.

The control section 130 is implemented by, for example, a central processing unit (CPU) or a micro processing unit (MPU) running a program stored in an internal storage device while using a RAM as a workspace. The control section 130 may also be implemented as, for example, an integrated circuit, such as an application specific integrated circuit (ASIC) or a field programmable gate array (FPGA). The control section 130 includes a first generating unit 131, a learning unit 132, a determination unit 133, a second generating unit 134, and an extraction unit 135 and implements or performs information processing functions and operations described later. It is noted that the internal configuration of the control section 130 is not limited to the configuration illustrated in FIG. 1 and may be any configuration that performs information processing described later.

The first generating unit 131 obtains, for example, logs for learning from a terminal via the communication section 110. The first generating unit 131 stores the obtained logs in the log storage unit 121. The first generating unit 131 generates the first training data, which is graph-structured data, in accordance with the obtained logs. The first generating unit 131 partitions the generated first training data to perform cross-testing by using DT. The first generating unit 131 generates evaluation data from the first training data by employing, for example, K-fold cross-validation or leave-one-out cross validation (LOOCV). When the amount of the first training data is relatively small, the first generating unit 131 may validate by using the first training data used for learning whether identification is accurate. The first generating unit 131 stores the generated first training data and the evaluation data in the training data storage unit 122. The first generating unit 131 outputs the first training data to the learning unit 132. The first generating unit 131 also outputs the evaluation data to the determination unit 133 and the extraction unit 135.

When determined pseudo training data is input from the extraction unit 135, the first generating unit 131 generates the second training data by adding the input determined pseudo training data to the first training data. The first generating unit 131 outputs the generated second training data to the learning unit 132 and stores the generated second training data in the training data storage unit 122.

When particular training data of the first to third training data is input from the first generating unit 131 or the determination unit 133, the learning unit 132 learns the particular training data of the first to third training data and accordingly generates the first machine learning model. Specifically, the learning unit 132 performs tensor decomposition on the particular training data of the first to third training data and generates core tensors (sub-graph structures). The learning unit 132 inputs the generated core tensors to a neural network and obtains output. The learning unit 132 performs learning to decrease the error of output value and learns parameters for tensor decomposition to achieve higher identification accuracy. Tensor decomposition has flexibility and examples of parameters for tensor decomposition include, for example, decomposition models, constraints, and optimization algorithms, which are used as a combination. Examples of decomposition model include canonical polyadic (CP) decomposition and Tucker decomposition. Examples of constraint include an orthogonal constraint, a sparse constraint, a smoothness constraint, and a non-negativity constraint. Examples of optimization algorithm include alternating least square (ALS), higher order singular value decomposition (HOSVD), and higher order orthogonal iteration of tensors (HOOT). In Deep Tensor, tensor decomposition is performed under the constraint that higher identification accuracy is achieved. In other words, the learning unit 132 trains the first machine learning model by using a plurality of items of determined pseudo training data (the third training data).

When learning of any training data of the first to third training data is completed, the learning unit 132 stores the first machine learning model in the machine learning model storage unit 124. It is possible to employ various types of neural network, such as a recurrent neural network (RNN) as the neural network. It is also possible to employ various method such as backpropagation as the learning method.

When fourth training data is input from the second generating unit 134, the learning unit 132 learns the fourth training data on the first machine learning model and generates a third machine learning model. When learning of the fourth training data is completed, the learning unit 132 outputs the third machine learning model to the extraction unit 135.

After the learning unit 132 completes learning of the first or second training data, the determination unit 133 determines, by using the first machine learning model in the machine learning model storage unit 124 and the evaluation data that is input from the first generating unit 131, whether the classification accuracy with respect to the evaluation data satisfies a desired level of accuracy. That is, the determination unit 133 evaluates the accuracy of cross-testing result obtained by using DT and determines whether the accuracy satisfies a desired level of accuracy.

When it is determined that the accuracy satisfies the desired level of accuracy, the determination unit 133 generates the third training data by adding all items of determined pseudo training data stored in the determined-pseudo-training-data storage unit 123 to the first training data. The determination unit 133 outputs the generated third training data to the learning unit 132 and stores the generated third training data in the training data storage unit 122.

When it is determined that the accuracy does not satisfy the desired level of accuracy, the determination unit 133 outputs to the second generating unit 134 the determination result and an instruction for generating pseudo training data.

After the learning unit 132 completes learning of the third training data, the determination unit 133 determines, by using the first machine learning model and the evaluation data that is input from the first generating unit 131, whether the classification accuracy satisfies a desired level of accuracy. That is, the determination unit 133 evaluates the accuracy of determination result obtained by using DT and checks that the accuracy satisfies a predetermined level of accuracy. When the accuracy of determination result does not satisfy the predetermined level of accuracy, the determination unit 133 modifies the third training data by, for example, reducing items of determined pseudo training data that are added when generating the third training data and performs again learning and determination.

When the determination result and the instruction for generation are input from the determination unit 133, the second generating unit 134 refers to the training data storage unit 122, determines a particular item of training data of the first training data as target data for pseudo training data, and designates the particular item of training data as selected training data. The particular item of training data is training data whose determination result indicates incorrect identification. The second generating unit 134 refers to the log storage unit 121 and generates modified logs in which logs are partially modified. The second generating unit 134 generates pseudo training data for selected training data in accordance with the generated modified logs.

The second generating unit 134 extracts, from the first training data, similar type training data corresponding to malware of a particular type similar (identical) to the type of the selected training data and different type training data corresponding to malware of another particular type different from the type of the selected training data. The second generating unit 134 generates, by learning the selected training data, and the extracted similar type training data and the extracted different type training data, the determiner that determines whether pseudo training data contributes to training. Specifically, similarly to the learning unit 132, the second generating unit 134 performs tensor decomposition on the selected training data, and the extracted similar type training data and the extracted different type training data and generates core tensors (sub-graph structures). The second generating unit 134 inputs the generated core tensors to the neural network and obtains output. The second generating unit 134 performs learning to decrease the error of output value and learns parameters for tensor decomposition to achieve higher identification accuracy. The second generating unit 134 stores the generated determiner in the machine learning model storage unit 124.

The second generating unit 134 determines, by using the generated determiner, whether the pseudo training data generated from the selected training data contributes to training. When determining that the pseudo training data does not contribute to training, the second generating unit 134 generates again pseudo training data. When determining that the pseudo training data contributes to training, the second generating unit 134 designates the pseudo training data as candidate data. The second generating unit 134 generates the fourth training data by adding the candidate data to the first training data. The second generating unit 134 outputs the generated fourth training data to the learning unit 132.

In other words, the second generating unit 134 generates the determiner in which training data of a particular type similar to the type of incorrectly identified training data is designated as a positive example while training data of another particular type different from the type of incorrectly identified training data and the incorrectly identified training data per se are designated as negative examples. The second generating unit 134 designates as candidate data of determined pseudo training data, by using the determiner, pseudo training data about which it is determined that the core tensor is changed.

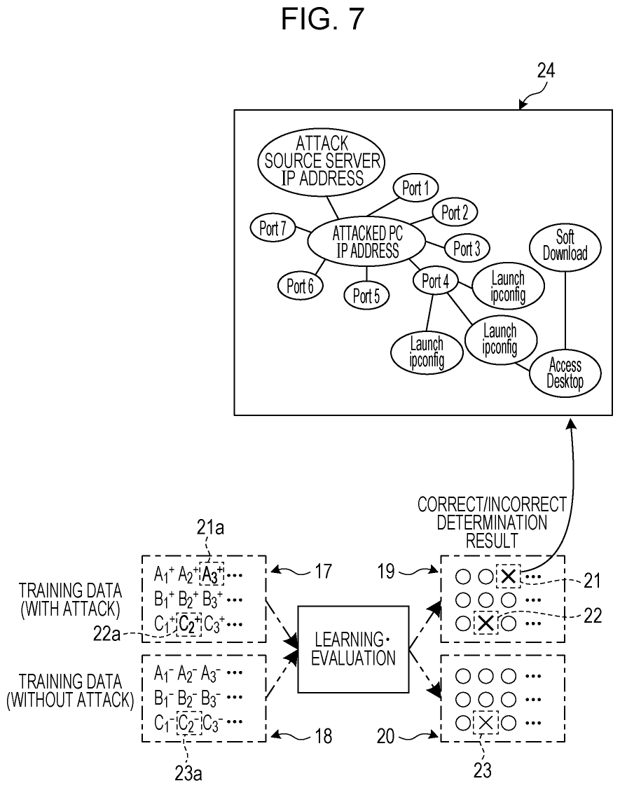

Here, generation of candidate data is described with reference to FIGS. 7 to 12. FIG. 7 illustrates an example of training data that is incorrectly identified. A training data group 17 illustrated in FIG. 7 is a set of training data with attack of the first training data. In contrast, a training data group 18 is a set of training data without attack of the first training data. The second generating unit 134 obtains correct/incorrect determination results 19 and 20 by performing learning and evaluation on the training data groups 17 and 18. In the correct/incorrect determination result 19, results 21 and 22 both indicate incorrect identification. In the correct/incorrect determination result 20, a result 23 indicates incorrect identification. This means that the results 21 and 22 are supposed to be identified as with attack but actually identified as without attack. By contrast, the result 23 is supposed to be identified as without attack but actually identified as with attack.

Accordingly, training data 21a and 22a corresponding to the results 21 and 22 and training data 23a corresponding to the result 23 are all incorrectly identified training data. At this time, the second generating unit 134 gives higher priority to the training data 21a and 22a, which are supposed to be identified as with attack but actually identified as without attack, than the training data 23a and firstly determines the training data 21a as a target. A graph 24 in FIG. 7 represents the training data 21a by using a graph structure.

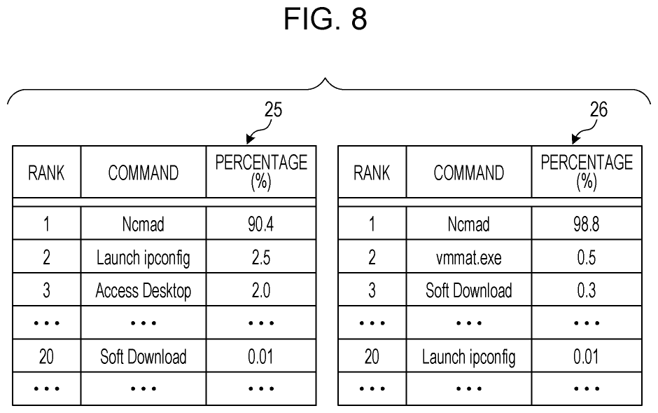

FIG. 8 illustrates an example of statistic data that is used for generating pseudo training data. Statistic data 25 illustrated in FIG. 8 indicates an example of logs in the case of attack before modification. The second generating unit 134 modifies partially the elements of the statistic data 25 and generates statistic data 26 that is modified logs. Since the statistic data 26 is based on the statistic data 25 in the case of attack while containing new information unlike the statistic data 25, there is a possibility that the statistic data 26 contributes to training of the first machine learning model. The modified logs may be generated in accordance with, for example, information in the field of security and knowledge about rule bases. As the logs for generating update logs, logs in the case of no attack may also be used.

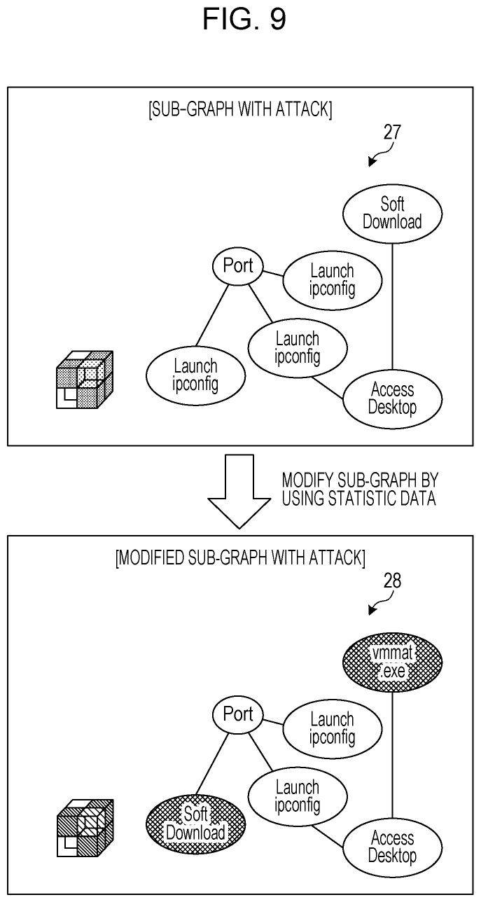

FIG. 9 illustrates an example of modification of a sub-graph. Sub-graphs 27 and 28 illustrated in FIG. 9 are sub-graphs correspondingly representing features of the statistic data 25 and 26 in FIG. 8. That is, the sub-graph 27 is modified by using the statistic data 26 and changed to the sub-graph 28.

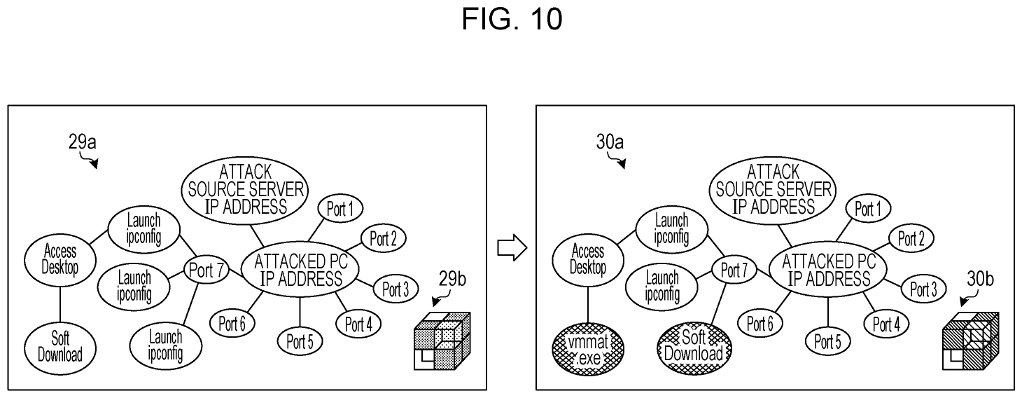

FIG. 10 illustrates an example of modification of a sub-graph indicated by using a core tensor. In a graph 29a illustrated in FIG. 10, a sub-graph representing a feature is expressed as a core tensor 29b. The graph 29a corresponds to training data with attack before modification, that is, the selected training data. The second generating unit 134 modifies partially logs corresponding to the graph 29a and generates a graph 30a. In the graph 30a, a sub-graph representing a feature is expressed as a core tensor 30b. The graph 30a corresponds to training data with attack after modification, that is, pseudo training data. This means that the graph 30a is a graph obtained by changing the core tensor 29b in the graph 29a to a core tensor 30b. Thus, pseudo training data corresponding to the graph 30a may contribute to training.

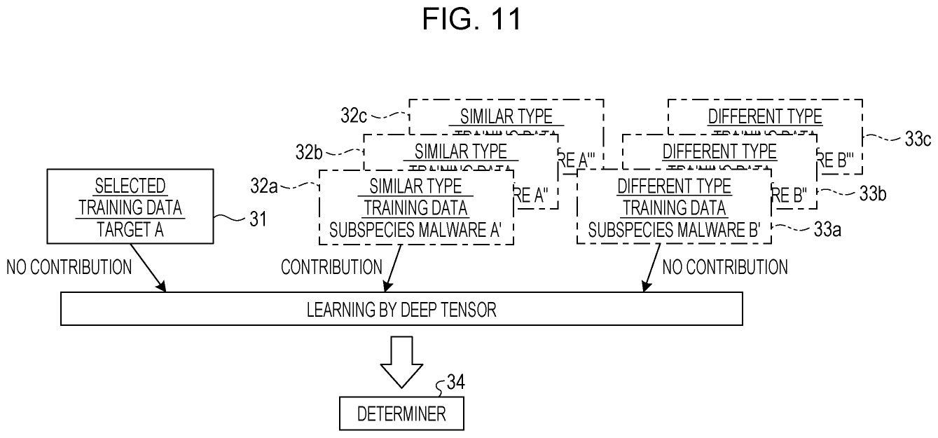

FIG. 11 illustrates an example of the determiner that determines whether pseudo training data contributes to training. Selected training data 31 illustrated in FIG. 11 corresponds to target A (malware A). Similar type training data 32a to 32c correspond respectively to malware A′ to A′″ that are of types similar to that of the malware A, which means that they are subspecies of the malware A. Different type training data 33a to 33c correspond respectively to malware B′ to B′″ that are of types different from the malware A. The second generating unit 134 performs learning with Deep Tensor by using the similar type training data 32a to 32c as positive examples (training data that contributes to training) and the selected training data 31, and the different type training data 33a to 33c as negative examples (training data that does not contribute to training), and consequently, the second generating unit 134 generates a determiner 34.

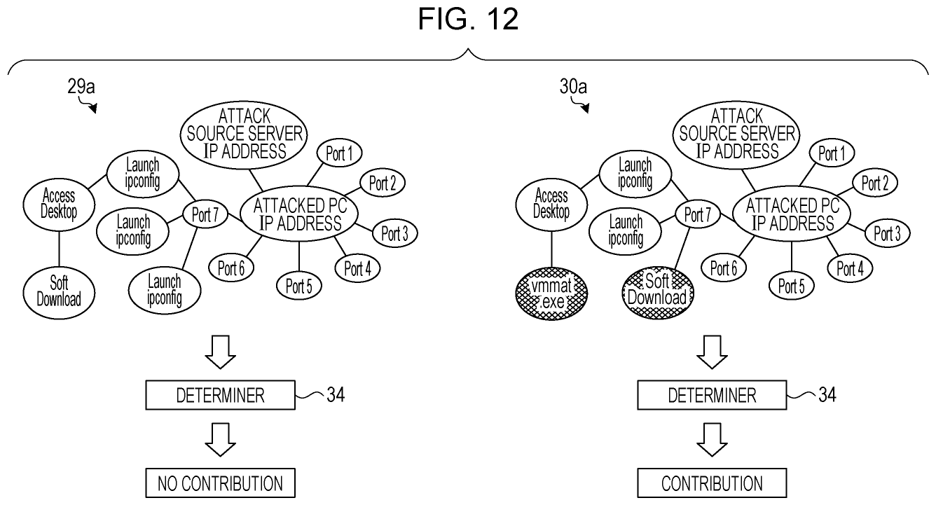

FIG. 12 illustrates an example of determination obtained by the determiner. FIG. 12 illustrates the case in which determination is performed for the graphs 29a and 30a illustrated in FIG. 10 by using the determiner 34 illustrated in FIG. 11. As illustrated in FIG. 12, since the graph 29a corresponds to the selected training data, that is, incorrectly identified training data, the determination result obtained by the determiner 34 indicates no contribution. By contrast, since the graph 30a corresponds to pseudo training data, the determination result obtained by the determiner 34 indicates contribution. In this case, the second generating unit 134 designates the pseudo training data corresponding to the graph 30a as candidate data.

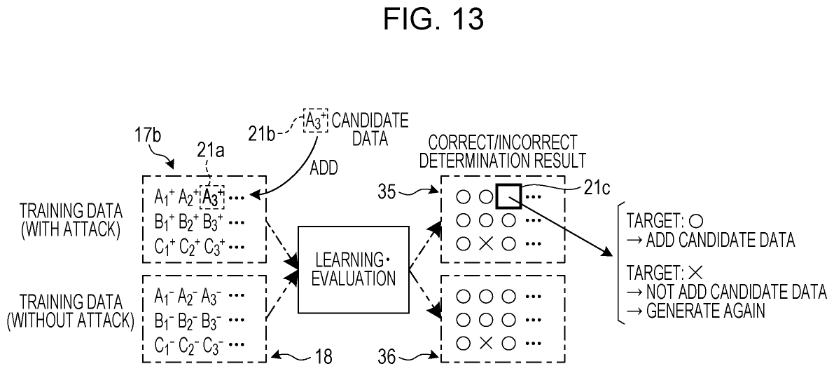

FIG. 13 illustrates an example of accuracy evaluation conducted on training data with added candidate data. Training data group 17b illustrated in FIG. 13 is a training data group obtained by adding candidate data 21b to the training data group 17 illustrated in FIG. 7. The second generating unit 134 obtains correct/incorrect determination results 35 and 36 by performing learning and evaluation on the training data groups 17b and 18. When in the correct/incorrect determination result 35 a result 21c (target) corresponding to the training data 21a is correctly identified, the second generating unit 134 employs the training data group 17b obtained by adding the candidate data 21b to the training data group 17. By contrast, the result 21c (target) corresponding to the training data 21a is incorrectly identified, the second generating unit 134 does not add the candidate data 21b to the training data group 17 and generates again candidate data. In this manner, the second generating unit 134 is able to generate candidate data that contributes to training.

Returning to the description of FIG. 1, when the third machine learning model is input from the learning unit 132, the extraction unit 135 performs cross-testing by using the third machine learning model that is input and evaluation data that is input from the first generating unit 131. The extraction unit 135 performs cross-testing and accordingly determines whether the level of classification accuracy about the evaluation data is higher than the level of classification accuracy of the first machine learning model. This means that the extraction unit 135 evaluates the accuracy of result of cross-testing performed by using DT and accordingly determines whether the accuracy of cross-testing is improved. When it is determined that the accuracy of cross-testing is not improved, the extraction unit 135 discards the candidate data and instructs the second generating unit 134 to generate subsequent pseudo training data.

When it is determined that the accuracy of cross-testing is improved, the extraction unit 135 extracts the candidate data as determined pseudo training data and stores the candidate data in the determined-pseudo-training-data storage unit 123. The extraction unit 135 also outputs the determined pseudo training data that is extracted to the first generating unit 131.

In other words, the extraction unit 135 extracts, from a plurality of items of pseudo training data generated from a plurality of items of training data (the first training data) for the first machine learning model, a plurality of items of determined pseudo training data that are determined as pseudo training data that promotes training of the first machine learning model. The plurality of items of pseudo training data are pseudo training data generated by using, as learning target data, incorrectly identified training data (selected training data) in cross-testing performed on the plurality of items of training data (the first training data). Moreover, the extraction unit 135 extracts a plurality of items of determined pseudo training data from candidate data generated by the second generating unit 134. Furthermore, the extraction unit 135 evaluates the accuracy of cross-testing by using training data with added candidate data (by using the third machine learning model), and when it is determined that the accuracy is improved, the extraction unit 135 extracts the candidate data as determined pseudo training data.

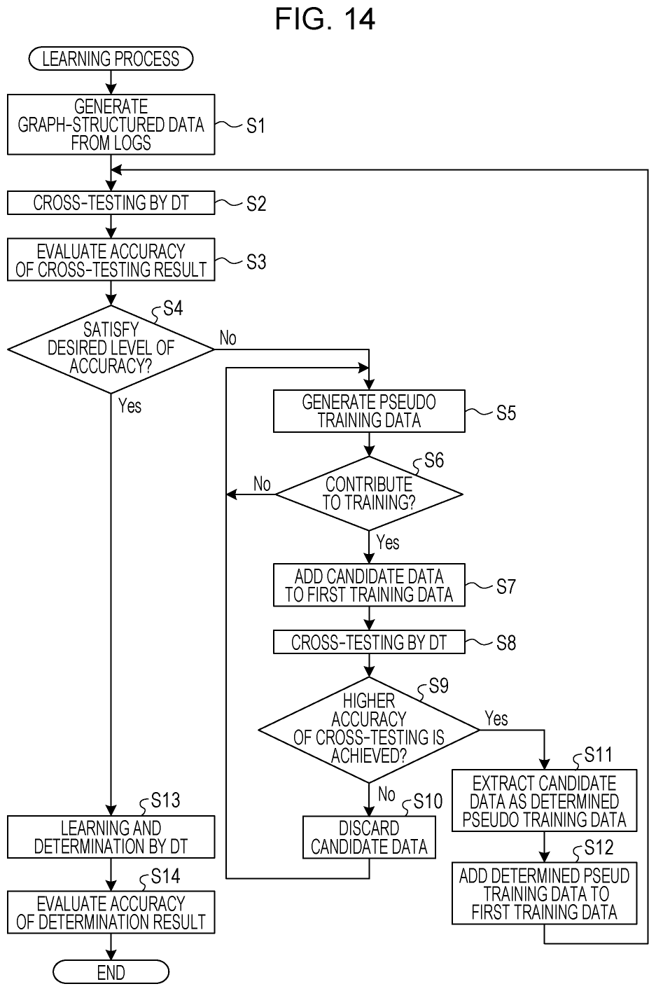

Next, operations of the learning apparatus 100 according to the embodiment is described. FIG. 14 illustrates an example of a flowchart of learning process according to the embodiment.

The first generating unit 131 obtains, for example, logs for learning from a terminal. The first generating unit 131 stores the obtained logs in the log storage unit 121. The first generating unit 131 generates the first training data, which is graph-structured data, in accordance with the obtained logs (step S1). The first generating unit 131 generates evaluation data from the first training data. The first generating unit 131 stores the generated first training data and the evaluation data in the training data storage unit 122. The first generating unit 131 outputs the first training data to the learning unit 132. The first generating unit 131 also outputs the evaluation data to the determination unit 133 and the extraction unit 135.

When the first or second training data is input from the first generating unit 131, the learning unit 132 learns the first or second training data and accordingly generates the first machine learning model. The learning unit 132 stores the generated first machine learning model in the machine learning model storage unit 124.

After the learning unit 132 completes learning of the first or second training data, the determination unit 133 performs cross-testing with DT by using the first machine learning model in the machine learning model storage unit 124 and the evaluation data that is input from the first generating unit 131 (step S2). The determination unit 133 evaluates the accuracy of cross-testing result obtained by using DT (step S3) and determines whether the accuracy satisfies a desired level of accuracy (step S4). When it is determined that the accuracy does not satisfy the desired level of accuracy (No in step S4), the determination unit 133 outputs to the second generating unit 134 the determination result and an instruction for generating pseudo training data.

When the determination result and the instruction for generation are input from the determination unit 133, the second generating unit 134 refers to the training data storage unit 122, determines a particular item of training data of the first training data as target data for pseudo training data, and designates the particular item of training data as selected training data. The particular item of training data is training data whose determination result indicates incorrect identification. The second generating unit 134 refers to the log storage unit 121 and generates modified logs in which logs are partially modified. The second generating unit 134 generates pseudo training data for the selected training data in accordance with the generated modified logs (step S5).

The second generating unit 134 extracts, from the first training data, similar type training data corresponding to malware of a particular type similar to the type of the selected training data and different type training data corresponding to malware of another particular type different from the type of the selected training data. The second generating unit 134 generates, by learning the selected training data, and the extracted similar type training data and the extracted different type training data, the determiner that determines whether pseudo training data contributes to training. The second generating unit 134 stores the generated determiner in the machine learning model storage unit 124.

The second generating unit 134 determines, by using the generated determiner, whether the pseudo training data generated from the selected training data contributes to training (step S6). When the second generating unit 134 determines that the pseudo training data does not contributes to training (No in step S6), the process returns to step S5. When determining that the pseudo training data contributes to training (Yes in step S6), the second generating unit 134 designates the pseudo training data as candidate data. The second generating unit 134 generates the fourth training data by adding the candidate data to the first training data (step S7). The second generating unit 134 outputs the generated fourth training data to the learning unit 132.

When fourth training data is input from the second generating unit 134, the learning unit 132 learns the fourth training data on the first machine learning model and generates a third machine learning model. When learning of the fourth training data is completed, the learning unit 132 outputs the third machine learning model to the extraction unit 135.

When the third machine learning model is input from the learning unit 132, the extraction unit 135 performs cross-testing with DT by using the third machine learning model that is input and the evaluation data that is input from the first generating unit 131 (step S8). The extraction unit 135 evaluates the accuracy of result of cross-testing performed by using DT and accordingly determines whether the accuracy of cross-testing is improved (step S9). When determining that the accuracy of cross-testing is not improved (No in step S9), the extraction unit 135 discards the candidate data (step S10) and the process returns to step S5.

When determining that the accuracy of cross-testing is improved (Yes in step S9), the extraction unit 135 extracts the candidate data as determined pseudo training data (step S11) and stores the candidate data in the determined-pseudo-training-data storage unit 123. The extraction unit 135 outputs the determined pseudo training data that is extracted to the first generating unit 131.

When determined pseudo training data is input from the extraction unit 135, the first generating unit 131 generates the second training data by adding the input determined pseudo training data to the first training data (step S12). The first generating unit 131 outputs the generated second training data to the learning unit 132 and the process returns to step S2.

When determining that the accuracy satisfies the desired level of accuracy (Yes in step S4), the determination unit 133 generates the third training data by adding all items of determined pseudo training data stored in the determined-pseudo-training-data storage unit 123 to the first training data. The determination unit 133 outputs the generated third training data to the learning unit 132.

When the third training data is input from the determination unit 133, the learning unit 132 learns the third training data and generates the first machine learning model. The learning unit 132 stores the generated first machine learning model in the machine learning model storage unit 124.

After the learning unit 132 completes learning of the third training data, the determination unit 133 determines, by using the first machine learning model and the evaluation data that is input from the first generating unit 131, whether the classification accuracy satisfies a desired level of accuracy. Specifically, the learning unit 132 and the determination unit 133 perform learning and determination with DT (step S13), evaluate the accuracy of determination result, and accordingly check that the accuracy satisfies a predetermined level of accuracy (step S14), and the learning process ends. In this manner, the learning apparatus 100 is able to hinder degradation of identification accuracy of a machine learning model using core tensors caused by learning pseudo training data. The learning apparatus 100 is also able to supplement variations of data with attack.

As described above, the learning apparatus 100 trains a machine learning model in which core tensors are generated. Moreover, the learning apparatus 100 extracts, from a plurality of items of pseudo training data generated from a plurality of items of training data for the machine learning model, a plurality of items of determined pseudo training data that are determined as pseudo training data that promotes training of the machine learning model. The learning apparatus 100 trains the machine learning model by using the plurality of items of determined pseudo training data. As a result, the learning apparatus 100 is able to hinder degradation of identification accuracy of a machine learning model using core tensors caused by learning pseudo training data.

In the learning apparatus 100, the plurality of items of pseudo training data are pseudo training data generated by using, as learning target data, incorrectly identified training data in cross-testing performed on the plurality of items of training data. As a result, the learning apparatus 100 is able to improve identification accuracy by learning incorrectly identified training data.

The learning apparatus 100 generates the determiner in which training data of a particular type similar to the type of incorrectly identified training data is designated as a positive example while training data of another particular type different from the type of incorrectly identified training data and the incorrectly identified training data per se are designated as negative examples. The learning apparatus 100 designates as candidate data of determined pseudo training data, by using the determiner, pseudo training data about which it is determined that the core tensor is changed and extracts a plurality of items of determined pseudo training data from the candidate data. As a result, the learning apparatus 100 is able to improve identification accuracy by learning pseudo training data that contributes to training.

Furthermore, the learning apparatus 100 evaluates the accuracy of cross-testing by using training data with added candidate data, and when it is determined that the accuracy is improved, the learning apparatus 100 extracts the candidate data as determined pseudo training data. As a result, the learning apparatus 100 is able to learn pseudo training data that improves identification accuracy.

It is noted that, while in the embodiments described above an RNN is used as an example of neural network, the neural network is not construed as being limiting in any way. Various types of neural network, such as a convolutional neural network (CNN), may also be applied. In addition, various known methods other than backpropagation may be applied as the learning method. The neural network is structured as a multiple-layer architecture composed of, for example, an input layer, an intermediate layer (a hidden layer), and an output layer and a plurality of nodes are joined by edges across the layers. Each layer has a function referred to as an activation function, edges have weights, and the value of each node is computed in accordance with the values of nodes in a preceding layer, the values of weights of joining edges, and the activation function owned by the corresponding layer. It is noted that various known methods may be used as the computation method. In addition, as the machine learning technology, various technologies other than neural networks, such as support vector machine (SVM), may be used.

Moreover, while in the embodiments the pseudo training data determined as pseudo training data that does not contribute to training and the candidate data determined as candidate data with which the accuracy of cross-testing is not improved are discarded, the configuration is not construed as being limiting in any way. For example, these kinds of pseudo training data and candidate data may be stored and reused at a later stage where learning proceeds.

Furthermore, while in the embodiments an item of determined pseudo training data is used for an item of incorrectly identified training data serving as a target, the configuration is not construed as being limiting in any way. For example, a plurality of items of determined pseudo training data may be used for a single target or a plurality of items of determined pseudo training data may be added for a plurality of targets at the same time.

Further, the components of parts illustrated in the drawings are not necessarily configured physically as illustrated in the drawings. This means that specific forms of dispersion and integration of the parts are not limited to those illustrated in the drawings, and all or part of thereof may be configured by being functionally or physically dispersed or integrated in any units depending on various loads, the usage state, and the like. For example, the second generating unit 134 and the extraction unit 135 may be integrated with each other. The order of the processes illustrated in the drawings is not limited to the examples described above, and the processes may be performed simultaneously or the order of the processes may be changed when there is no contradiction in the processes.

Moreover, all or any of the various processing functions performed on the devices may be performed on a CPU (or a microcomputer, such as an MPU or a micro controller unit (MCU)). As might be expected, all or any of the various processing functions may be performed by a program analyzed and run by a CPU (or a microcomputer, such as an MPU or an MCU) or on a hardware device using a wired logic coupling.

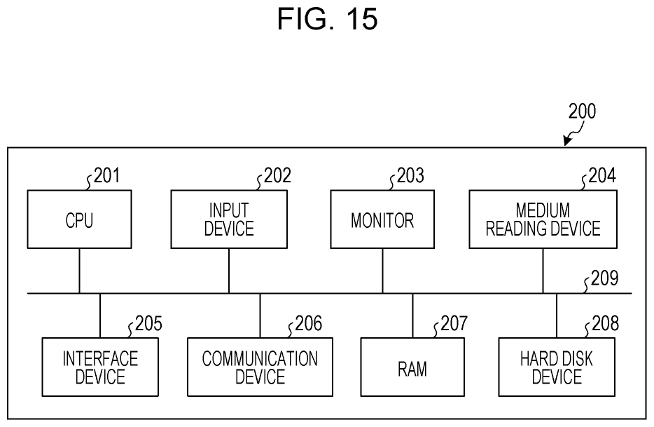

The various processes explained in the above description of the embodiments may be implemented by running a prepared program on a computer. Hereinafter, an example of a computer that runs a program implementing the same functions as those of the embodiments is described. FIG. 15 illustrates an example of a computer that runs the learning program.

As illustrated in FIG. 15, a computer 200 includes a CPU 201 that performs various kinds of arithmetic processing, an input device 202 that receives data inputs, and a monitor 203. The computer 200 also includes a medium reading device 204 that reads a program or the like from a recording medium, an interface device 205 that is coupled to various devices, and a communication device 206 that establishes wired or wireless coupling with an information processing device or the like. The computer 200 also includes a RAM 207 that temporarily stores various kinds of information and a hard disk device 208. The components 201 to 208 are coupled to a bus 209.

The hard disk device 208 stores the learning program that implements the same functions as those of the processing units, that is, the first generating unit 131, the learning unit 132, the determination unit 133, the second generating unit 134, and the extraction unit 135 that are illustrated in FIG. 1. The hard disk device 208 also stores various kinds of data used for achieving the functions of the log storage unit 121, the training data storage unit 122, the determined-pseudo-training-data storage unit 123, the machine learning model storage unit 124, and the learning program. The input device 202 receives, for example, inputs of various kinds of information such as operational information from a user of the computer 200. The monitor 203 displays various screens such as a display screen for the user of the computer 200. The interface device 205 is coupled to, for example, a printing device. The communication device 206 has a function identical to that of, for example, the communication section 110 illustrated in FIG. 1 and is coupled to a network to exchange various kinds of information with the information processing device.

The CPU 201 performs various processes by reading programs stored in the hard disk device 208, loading the programs into the RAM 207, and running the programs. The programs cause the computer 200 to function as the first generating unit 131, the learning unit 132, the determination unit 133, the second generating unit 134, and the extraction unit 135 that are illustrated in FIG. 1.

It is noted that the learning program is not necessarily stored in the hard disk device 208. For example, the computer 200 may read and run the learning program stored in a recording medium that is readable for the computer 200. The recording medium readable by the computer 200 corresponds to, for example, a portable recording medium, such as a compact disc read-only memory (CD-ROM), a digital versatile disc (DVD), or Universal Serial Bus (USB) memory, a semiconductor memory, such as a flash memory, or a hard disk drive. The learning program may be stored in a device coupled to, for example, a public network, the Internet, or a local area network (LAN) to be read and run by the computer 200.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a learning program for causing a computer to execute a process, the process comprising:
extracting, from a plurality of items of pseudo training data generated from a plurality of items of training data for a machine learning model in which core tensors are generated, a plurality of items of determined pseudo training data that are determined as pseudo training data that promotes training of the machine learning model; and
training the machine learning model by using the plurality of items of determined pseudo training data.

2. The non-transitory computer-readable recording medium according to claim 1, wherein the plurality of items of pseudo training data are generated by using, as learning target data, incorrectly identified training data in cross-testing performed on the plurality of items of training data.

3. The non-transitory computer-readable recording medium according to claim 2, wherein the extracting includes designating, as a set of candidate data of determined pseudo training data, a set of pseudo training data about which it is determined that the core tensors are changed and extracting the plurality of items of determined pseudo training data from the set of candidate data by using a determiner in which training data of a particular type similar to a type of incorrectly identified training data is designated as a positive example while training data of another particular type different from the type of incorrectly identified training data and the incorrectly identified training data are designated as negative examples.

4. The non-transitory computer-readable recording medium according to claim 3, wherein the extracting includes evaluating accuracy of cross-testing by using training data together with the set of candidate data that is added, and when it is determined that the accuracy is improved, extracting the set of candidate data as determined pseudo training data.

5. A learning method for causing a computer to execute a process, the process comprising:
extracting, from a plurality of items of pseudo training data generated from a plurality of items of training data for a machine learning model in which core tensors are generated, a plurality of items of determined pseudo training data that are determined as pseudo training data that promotes training of the machine learning model; and
training the machine learning model by using the plurality of items of determined pseudo training data.

6. A learning apparatus to execute a process for training a machine learning model, the learning apparatus comprising:
a memory, and
a processor coupled to the memory and performing a process including:
extracting, from a plurality of items of pseudo training data generated from a plurality of items of training data for the machine learning model in which core tensors are generated, a plurality of items of determined pseudo training data that are determined as pseudo training data that promotes training of the machine learning model; and
training the machine learning model by using the plurality of items of determined pseudo training data.
